(19) United States
(12) Patent Application Publication
(10) Pub. No.: US 2004/0221492 A1
(43) Pub. Date: Nov. 11, 2004

(54) Card with three dimensional visual effect

(76) Inventor: Evan Meredith Reiman, Auckland (NZ)

Correspondence Address: LAW OFFICE OF, JACOBSON HOLMAN, PROFESSIONAL LIMITED LIABILITY COMPANY, 400 SEVENTH STREET, N. W., WASHINGTON, DC, 20004, US

(21) Appl. No.: 10/429,953

(22) Filed: May 6, 2003

(51) Int. Cl. G09F 1/00

(52) U.S. Cl. 40/124.01

(57) ABSTRACT

A card with three dimensional visual effect comprising a transparent or translucent substrate of a flat nature and having a first major surface and an opposite second major surface. An opaque first layer of ink is printed over (and preferably onto) at least part of the first major surface of the substrate. A second layer of ink is printed over (and preferably onto) at least part of the second major surface of the substrate. An opaque masking layer of ink is printed onto at least part of the second layer to capture at least part of the second layer between the substrate and the masking layer. The first layer is provided on the first major surface side of the substrate in a region or regions selected whereby visual exposure of part of the second layer is provided, visible from the first major surface side of the card.

### FIELD OF INVENTION

The present invention relates to a card with three dimensional visual effect. In particular although not solely the present invention relates to a card which may be a collectable card or tradable card such as those often associated with the teenage market, business cards, swing tags or labels or the like.

### BACKGROUND

Traditionally collectors cards have consisted of a paper or cardboard substrate onto which printed information is presented. Likewise business cards have also been of such a traditional form. However with an increase in the importance of marketing and presentation new opportunities exist. Furthermore it is envisaged that a market exists where cards are provided by organisations as giveaways or as prizes wherein the card includes a tearaway or frangible portion which acts as a voucher or concession to be redeemed for goods or services. For example a collectors card which may be of a persons favourite or liked pop icon may predominantly provide an image and or related graphics of the pop icon but may also contain a portion which is frangible which may provide the owner of the card with a discount for the purchase of for example a music CD or concert tickets or the like. In such instances it becomes important that some sort of security aspect is associated with the card. Were the card to be of paper board substrate with information printed directly onto the substrate in a full coverage manner, with today's scanning and computer technology it is becoming more and more convenient for forgery to occur. It would hence be an advantage if a layered printing technique were adopted which is clearly visible to the naked eye which provides enhanced security as well as providing desirable visual effects to enhance the appeal of such a card.

Accordingly it is an object of the present to provide a card with three dimensional visual effect which addresses the above advantages or which will at least provide the public with a useful choice.

### BRIEF DESCRIPTION OF THE INVENTION

Accordingly in a first aspect the present invention consists in a card with three dimensional visual effect comprising

a transparent or translucent substrate of a flat nature and having a first major surface and an opposite second major surface

an opaque first layer of ink printed over (and preferably onto) at least part of said first major surface of said substrate and

a second layer of ink printed over (and preferably onto) at least part of said second major surface of said substrate

an opaque masking layer of ink printed onto at least part of said second layer to capture at least part of said second layer between said substrate and said masking layer,

wherein said first layer is provided on said first major surface side of said substrate in a region or regions selected whereby visual exposure of part of said second layer is provided, visible from said first major surface side of said card.

Preferably said first layer is block applied to at least said part of said first major surface, save for including a region of regions within its perimeter where an opening or openings are provided through such first layer and whereby part of said second layer is visible from said first major surface side of said card thought at least part of at least one of said opening(s).

Preferably said second layer is of a colour or colours which contrast with said first layer.

Preferably said second layer is of a colour or colours which contrast with said masking layer.

Preferably said second layer is of a colour or colours which is the same as said masking layer.

Preferably said masking layer is applied over the entire second layer.

Preferably said masking layer captures all of said second layer.

Preferably said masking layer captures most of said second layer.

Preferably said masking layer overlies most of said second layer.

Preferably said masking layer is pattern applied and defines a non applied region thereof over said second layer where said second layer is visible from said second major surface side of said card.

Preferably said first layer is of a one ink colour only.

Preferably said first layer is of a first colour applied in one region over said first major surface and of at least one other colour applied in a different region over said first major surface.

Preferably an over layer of ink is provided over at least part of said first layer.

Preferably said over layer is applied directly onto at least part of said first layer.

Preferably said over layer is a layer defining indicia printed onto said first layer.

Preferably said over layer is text printed onto said first layer.

Preferably said over layer is of a contrasting colour to said first layer.

Preferably said region or regions of said first layer through which said second layer is visible are openings of said first layer defining reverse text such that the second layer visible though said openings provides the colour to the legible text visible from said first major surface side of said card as defined by said openings of said first layer.

Preferably said over layer is provided about said region(s) of said first layer where said openings are provided and wherein corresponding openings are provided through said over layer.

Preferably said second layer is not coextensive with said substrate and defines regions where no second layer is applied to said substrate, at least some of such being regions at least partially transparency through said card.

Preferably said second layer is blanked applied to said second major surface of said substrate save for at least one non applied region within the bounds of said second layer.

Preferably on said first major surface side of said substrate, a non coated region remains which is commensurate with at least part of said non applied region of said second major surface.

Preferably said first layer is applied to said first major surface of said substrate, save for at least at regions where said non applied region of said second layer is provided.

Preferably at said non applied region, the edge of said first layer is commensurate with the edge of said second layer save for an offset parallel therewith along at least part of said edge of said second layer bounded by said non applied region, in order to reveal a thin line of said second layer bounded by said non applied region and visually bounded by said first layer when viewed from said first major surface side of said card.

Preferably no over layer is provided where said non applied region of said second layer exists.

Preferably on said second major surface side of said substrate, a non coated region remains which is commensurate with said non applied region of said second major surface.

Preferably said opaque masking layer is applied over said second layer, save for at least at regions where said non applied region of said second layer is provided.

Preferably said masking layer is applied over said second layer save for a region offset and parallel to at least part of an edge of said second layer at said non applied region.

Preferably said edge of said second layer is provided within the bounds of said second layer.

Preferably the edge of said masking layer is commensurate with said second layer save for an offset parallel therewith along at least part of an edge thereof adjacent said non applied region, in order to reveal a thin line of said second layer bounded by said non applied region and bounded by said second layer when viewed from said second major surface side of said card.

Preferably said opaque masking layer has printed text or graphics provided thereon visible from the second major surface side of said substrate.

Preferably said second layer is blanket applied to the entire second major surface of said substrate save for said non applied regions and save for an offset inwardly from the perimeter of said substrate.

Preferably said opaque masking layer does extend to the perimeter of said substrate and beyond said region off set of said second layer to said substrate perimeter where said masking layer is applied directly onto said second major surface of said substrate.

Preferably said offset inwardly from said perimeter is approximately 0.5 mm.

Preferably said second layer is substantially coextensive with said opaque masking layer save for at said offset inwardly from said perimeter.

Preferably said second layer is substantially co extensive with said opaque masking layer save for said offset inwardly from said perimeter and said offset of said opaque layer from said edge of said second layer adjacent said non coated region.

A further variation to the card is in respect of the type of information that is presented on it. A standard business card normally has a single rectangular substrate made of paper onto which on one side, there is provided detail of the company, an individual name and contact details. Business cards are handed to clients or acquaintances for the purposes of having relevant information conveniently at hand for that person to which the business card is given.

When a business card is handed out to a person, the recipient is normally the end user of that card and for future reference, the end user will refer to the card to obtain contact details of the individual who handed the card out. The standard business card therefore provides a means for single point of future reference normally for a single user to whom the business card has been handed. Whilst a particular business card may be handed from person to person, the business card remains a single discreet item and is normally kept as a record as a single point of reference.

As an example however the person to whom the business card has been handed to may wish to disseminate the information on the business card further. The person may be pleased with the service that was provided and wishes to make a recommendation of the person on the business card, to a friend or colleague. Since regular business cards are a single point of reference, a photocopy may need to be taken of the business card to provide contact details to further people. A photocopied business card does not provide the best visual impression that the original business card may have provided.

The 3 D visual effect created by on the card as herein above described may hence also act as a business card of a card of a kind as herein before described of a sheet of material providing a first and second exposed major surface, said sheet defining at least two portions separated by a line of weakness,

wherein the first major surface of a first portion provides indicia of a first kind and the second major surface of the second portion provides indicia substantially similar said indicia of said first kind and

wherein the second portion of the first major surface provides indicia of a second kind and the first portion of said second major surface provides indicia substantially similar said indicia of said second kind.

Preferably said indicia of said first kind is different to that of said second kind.

Preferably said indicia of said first kind includes a persons name.

Preferably said indicia of said first kind includes a company name.

Preferably said indicia of said first kind includes a logo or slogan of descriptive matter realign to the activities of the company with said company name.

Preferably said indicia of said second kind includes contact details.

Preferably said indicia of said second kind includes a persons name.

Preferably said first portion is larger than said second portion.

Alternatively said first portion is smaller than said second portion.

Alternatively said first portion is the same size as said second portion.

Preferably said business card is rectangular in shape.

Preferably said line of weakness is a line of perforations.

Preferably said line of weakness extends between the longer of said sides of said rectangular shaped business card.

Preferably said first kinds of indicia are also graphically of a similar layout.

Preferably said second kinds of indicia are also graphically of a similar layout.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth. For the purposes of illustrating the invention, there is shown in the drawings a form which is presently preferred. It is being understood however that this invention is not limited to the precise arrangements shown.

### BRIEF DESCRIPTION OF THE DRAWINGS

FIG. 1 is a front view of a business card utilising the layered structure of the present invention,

FIG. 2 is a sectional view through section XX of FIG. 1,

FIG. 3 is a rear view of the business card of FIG. 1,

FIG. 4 is a plan view of an alternative configuration,

FIG. 5 is a sectional view through section AA of FIG. 4,

FIG. 6 is a rear view of FIG. 4,

FIG. 7 is a view of an alternative configuration,

FIG. 8 is a sectional view through BB of FIG. 7,

FIG. 9 is a rear view of FIG. 7,

FIG. 10 is a plan view of an alternative configuration,

FIG. 11 is a sectional view through section CC of FIG. 10,

FIG. 12 is a rear view of FIG. 10,

FIG. 13 illustrates a plan view of an alternative arrangement,

FIG. 14 is a sectional view through section DD of FIG. 13,

FIG. 15 is a rear view of FIG. 13,

FIG. 16 illustrates a frangible version of a card incorporating any one or more of the alternatives as shown in FIGS. 1 to 15 wherein the frangible portion is removable and wherein the frangible portion may also contain the layered effect of any one or more of FIGS. 1 to 15,

FIG. 17 is a view of a first major surface of a business card of the present invention which can incorporate the 3d visual effects as described in any one or more of the variations as described with reference to FIGS. 1 to 15,

FIG. 18 is a view of the other major surface of the business card of the present invention, and

FIG. 19 is a three portioned card having three separable regions 108, 109, 110 on each face.

### BRIEF DESCRIPTION OF THE INVENTION

FIG. 1 is a plan view of a business card. The business card is for example of a substantially rectangular plan shape and FIG. 1 illustrates one side of the business card.

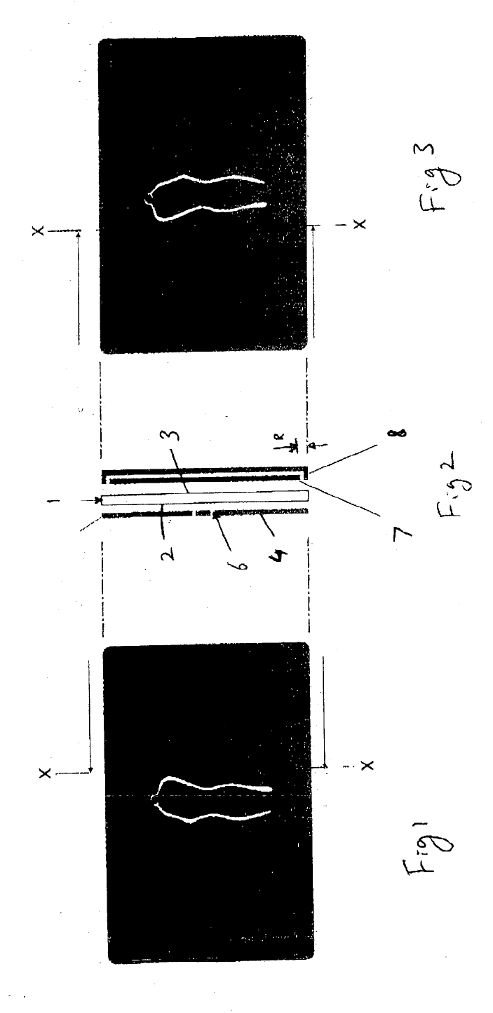

FIG. 3 is a rear view of the business card of FIG. 1. Information such as graphics and contact details (ph, fax, email, web address etc.) may be provided on one or both sides of the card.

With reference to FIG. 2 which is a cross section through section XX of FIGS. 1 and 3 it can be seen that the card consists of a substrate 1 which is preferably made of a transparent or translucent material. In the most preferred form the substrate 1 is made from a clear plastics material although it is envisaged that a coloured plastics material which is translucent may alternatively be provided. The substrate 1 defines the shape and structure to the card. The substrate 1 includes a first major surface 2 and a second major surface 3 which faces opposite to the direction of the first major surface 2. The substrate 1 is preferably of a flexible material but is sufficiently rigid to maintain its structural integrity and preferably prevent it from being creased.

Provided on the first major side 2 of the substrate 1 is a first layer of ink which has been deposited preferably directly onto the first major surface 2 of the substrate 1 by a printing process. The first layer 4 is preferably provided directly onto the first major surface 2 of the substrate 1 in a manner which may be substantially coextensive with the first major surface 2 as for example shown in FIG. 1. It is envisaged that further printing such as text may be provided on top of the first layer 4 by way of an overlayer 5. The overlayer only partially covers the first layer. The overlayer 5 is of a colour which contrasts the first layer 4. The provision of an overlayer is however optional.

The first layer 4 is preferably substantially coextensive with the first major surface 2 of the substrate 1. However some regions may not be provided with the first layer 4 and indeed there are provided regions in the first layer 4 where openings 6 are provided therethrough and through which the transparent substrate 1 is visible.

Provided on the side of the substrate 1 to the second major surface 3 is a second layer 7. This second layer 7 is also preferably substantially coextensive with the substrate 1. Indeed the second layer 7 extends sufficiently so that provided through the openings 6 of the first layer 4, the second layer 7 will be visible through the transparent or translucent substrate 1. The opening(s) 6 of the first layer 4 is/are preferably provided in a manner so as to provide a graphic or text like negative image such that when viewed from the first major surface side of the card, the openings through the first layer 4 are of a colour of the second layer 7 and as a result of the shape of the openings, the indicia that is visible is of a colour of the second layer. Most preferably although not essentially, the second layer 7 is of a contrasting colour to the first layer 4. As a result of the second layer 7 being visible through the opening(s) 6 of the first layer 4 and through the transparent substrate 1, the image that is visible through the openings appears to be offset from the exposed surface of the first layer 4. This accordingly creates a three dimensional effect. As a result to some extent, the casting of a shadow occurs of the first layer 4 around the perimeters of the openings 6 onto the second layer 7. This enhances the three dimensional effect. Furthermore with the provision of an ink of the first layer 4 which is of a different reflectiveness to the reflectiveness of the substrate 1, the parent reflectiveness of the second layer 7 through the openings 6 to the first major surface side of the card will also be different to the reflectiveness of the exposed surface of the first layer 4.

For example a solid black print may be provided onto the first side of the clear substrate and the words of a business may be reversed out of the black print. The words are hence essentially clear. With the provision of for example a red ink to the second major surface of the clear substrate a red company name appears from the first side of the card with a black background.

To make such an appearance elusory an opaque masking layer 8 is preferably provided over the entire second layer 7. The masking layer 8 captures the second layer 7 between the transparent substrate and the masking layer such that when the card is reversed a person will (in a preferred form) not see any of the second layer 7. The second layer 7 is hence trapped between the transparent substrate and the masking layer 8. For the purposes of carefully capturing the second layer 7 within the bounds of the substrate 1 and the masking layer 8, the second layer 7 preferably includes an edge bleed such that the second layer 7 is not quite coextensive with the perimeter of the substrate 1. An edge bleed R of a few or fraction of a mm provides an offset to the perimeter of the second layer 7 away from the edge of the substrate 1 and the masking layer 8 which is preferably coextensive with the perimeter of the substrate 1. Hence at the edges of the card there is no visible second layer 7. Furthermore in the provision of manufacturing of the preferred form of this card, this edge bleed provides further advantages to which reference will be made hereinafter.

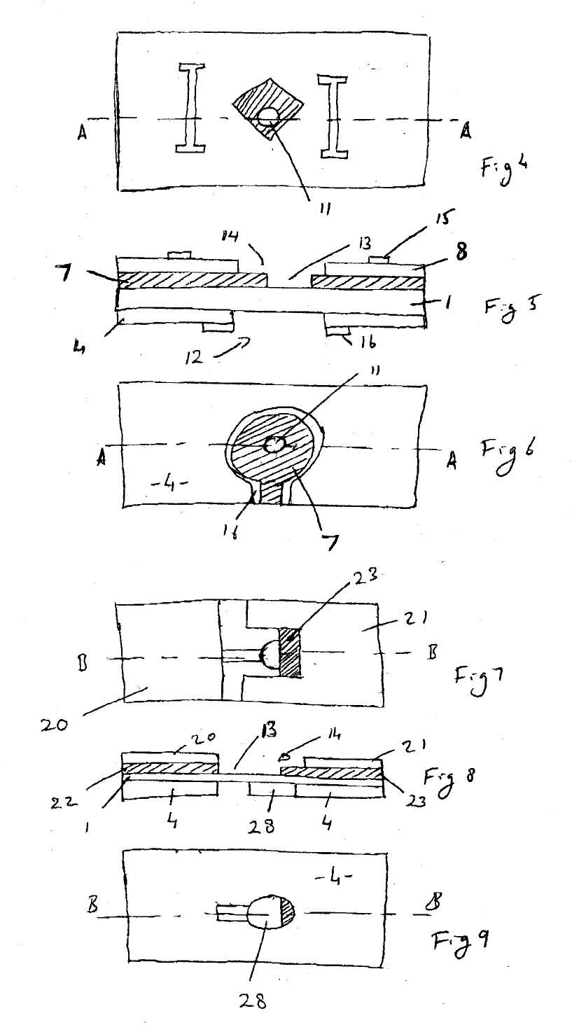

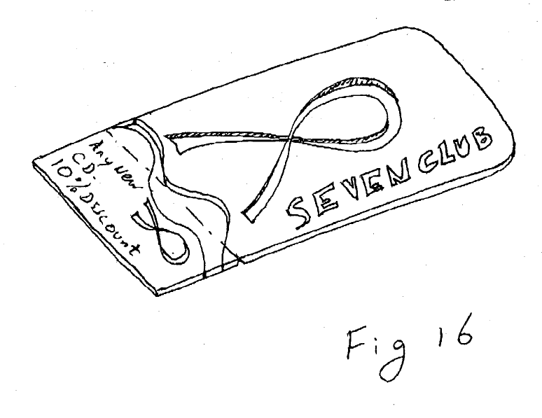

Having described the basic form of the invention further variations will now be explained with reference to FIGS. 4 to 15. FIGS. 4 to 15 all have a common feature that there is a region of transparency through the entire card. With reference to FIGS. 4 to 6, such a region or transparency 11 is preferably provided within the bounds of the perimeter of the substrate. Where reference herein is made to the bounds, it is to be interpreted as the exterior most perimeter. Whilst interior perimeter edges may be provided in any one or more of the layers described, the bounds refers to the exterior perimeter of any such layer or the substrate.

With reference to FIGS. 4 to 6, the second layer 7 in addition to the first layer 4 includes an opening therethrough. Whilst the opening through the first layer may be an opening provided within the bounds of the first layer 4, it may be that the first layer 4 may be two separate regions of ink deposited on the first major surface 2 of the substrate 1. Indeed the opening 12 of the first layer 4 may extend to the edge of the perimeter of the substrate 1 and it may be that the layer 4 is provided as more than one region with the opening provided therein. The opening of the first layer 4 extends to the perimeter of the substrate and it may be that the layer 4 may be of two or more discrete regions with an opening separating each region therebetween. To the extent that the second layer 7 is provided non-commensurate with the opening of the first layer 4, the second layer 7 will be visible from the first side (that side in the direction of the first major surface 2) of the card. This is for example shown in FIG. 6. To the extent that the opening 13 of the second layer 7 lies within or is at least in part overlapping with the opening 12 of the first layer 4, a transparent region through the card can be created. The masking layer 8 preferably also includes an opening 14 therethrough which is at least of a size and shape corresponding to the opening 13 of the second layer 7, a transparent opening is created through the entire card. The transparent region 11 will allow light through the card and this creates a novel effect. The opening 13 of the second layer 7 may also extend to the perimeter of the card although as shown in FIGS. 4 to 6, the opening 13 is contained within the bounds of the second layer 7. The opening 13 of the second layer 7 may be identical to the shape and size of the opening 12 of the first layer 4. If this is the case then when viewed from the first side of the card, no part of the second layer 7 will be visible at such a region. Such a configuration may hence be provided in combination with the three dimensional captured layer effect as defined with reference to description of FIGS. 1 to 3. Indeed the mannequin form of the card illustrated in FIGS. 1 to 3 provide all of the layers 4, 7 and 8 in an identical manner at the mannequin form and create a transparent mannequin form through the card. In order however to create a three layered stepping effect, the opening 12 of the first layer 4 may be of a different size and preferably larger size than the opening 13 to the second layer 7. When viewed from the first side of the card, a person will see the first layer 4 step through to the transparent layer to the second layer 7 and step through the transparent layer where the entirely transparent section 11 is provided to the background to which the card is held against. The nature of the opening 12 of the first layer 4 may be such that it is slightly larger with a parallel offset to the shape of the opening 13 of the second layer 7. In this manner a three dimensional lining effect to the shape of the opening 12 of the first layer 4 can be provided by the visible appearance of a thin line of the layer 7 which from the first side is bounded by its edge at the opening 13 and visually bounded by the edge of the layer 4 at the opening 12. Such is for example shown in FIG. 15.

With reference to FIG. 4, the masking layer is provided with an overlayer 15 of ink which has been printed thereon which may for example be text or other graphics. The overlayer is not coextensive and is smaller than the second layer. Provided on one or both sides of the card may be a layer of a clear transparent material such as for example a high gloss UV varnish although this is not essential.

Where a card is provided with a transparent region therethrough, the opening 12 of the first layer 4 is preferably in most regions larger than the opening 13 of the second layer 7 to thereby still create the three dimensional effect. However in a form where the opening 13 is coextensive with the opening 12 further regions on the card may be provided where a three dimensional effect as described with reference to FIGS. 1 to 3 or with reference to FIG. 4 to 15 are provided.

With reference to FIG. 5, it can also be seen that the masking layer 8 has an opening 14 therethrough which is larger than the opening 13 of the second layer 7. Whilst from the second side the three dimensional effect thereby provided will be significantly negligible since the layers are so thin as to appear to be of the same depth (layers 7 and 8) with the provision of an opening 14 through the masking layer 8 which is slightly larger, advantage can be taken of the colouring of the second layer 7 for creating additional visual effects on the second side of the card. However in other forms, the opening 14 of the masking layer 8 may be commensurate and coextensive with the second layer 7. An option exists to provide an overlayer 16 to the first layer 4 which may extend about the opening 12 of the first layer 4. Any such additional layer may provide an enhancement to the visual effect of the transparent region through the first layer 4. Such an overlay may be provided whether or not a transparency is created through the openings 13 and 14 of the second layer 7 and masking layer 8. The overlayer 16 provided to the first layer 4 preferably has the same opening as the opening 12 to the first layer 4 although this need not be necessary.

With reference to FIGS. 7 to 9, there is shown a masking layer which consists of two discrete regions 20 and 21. The opening 14 to the masking layer 20, 21 extends between the two perimeter edges of the card. Likewise the second layer 7 is made up of two discrete regions 22 and 23 which are likewise separated due to the extension of the opening 13 extending to the perimeter of the substrate 1. The masking layer region 20 and the second layer region 22 are coextensive with each other. The masking layer region 21 and that region 23 of the second layer are not coextensive and as can be seen from the second side shown in FIG. 7, part of the region 23 of the second layer is visible from the second side.

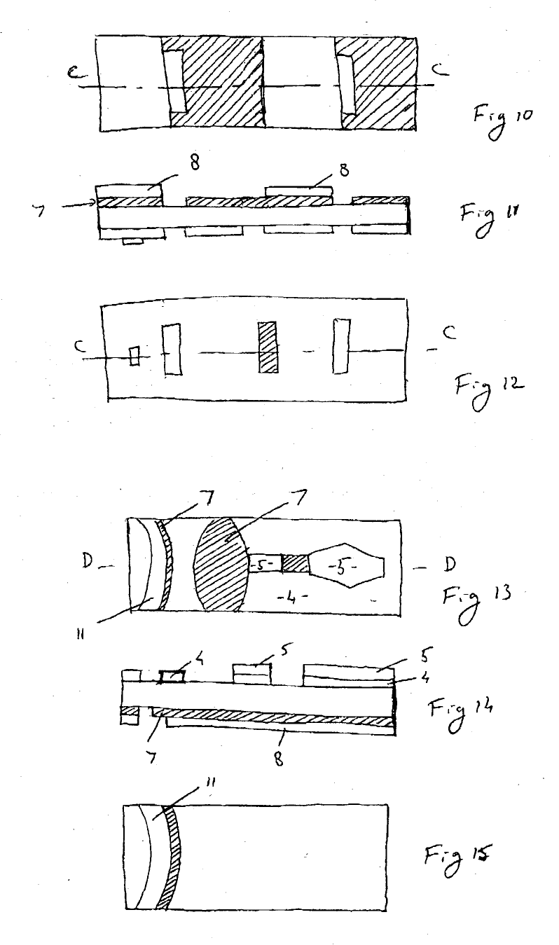

With reference to FIG. 8 the first layer 4 is preferably continuous and provides an opening therethrough within the bounds of the layer 4. However in addition to the layer 4 there is provided a translucent layer 28 which has been printed within the opening of the first layer 4. This translucent layer provides an additional visual effect to the arrangement.

With reference to FIGS. 10 to 12, it can be seen that whilst previously a substantial part of the second layer 7 has been captured by the masking layer 8, in this alternative this is not so. FIGS. 13 to 15 illustrate alternative arrangements where for example shown in FIG. 13, part of the second layer 7 is visible as a line which is parallel to the edge of the first layer 4 adjacent the transparent opening 11.

Whilst in FIGS. 4 to 15 there is no perimeter edge bleed shown of the second layer 7, such a feature may be incorporated into any one or more of the configurations by way of illustration shown in FIGS. 4 to 15. Where transparency through the card extends through to the perimeter as for example shown in FIGS. 13 to 15, no layers are provided at the perimeter edge of the transparent substrate 1. Hence no edge bleeding at the perimeter there at is provided.

The provision of an edge bleed ensures that the second layer remains captured within the layers provided by the transparent substrate and the masking layer but also reduces the number of layers of ink that are provided at the perimeter of the substrate.

It is envisaged that the cards of the present invention will be produced on mass from a large sheet of transparent material where a plurality of regions are printed. Once the printing has been completed, cards will be separated from the sheet by a cutting process. Such a cutting process is normally a cutting press and will puncture individual cards from the sheet. In order to ensure that a minimal thickness of ink is to be penetrated by the cutting edge, the provision of the edge bleed will ensure that the cutting blade does not penetrate through the second layer. The cutting blade hence may only need to penetrate through the masking layer, the transparent substrate and the first layer. This ensures that integrity of the ink at the perimeter is maintained. Were a significant number of layers to be provided at the perimeter, a brittling effect may be induced by the cutting process and may result in the ink from chipping, pealing or otherwise losing its integrity. In the most preferred form, the cutting will advance through the plastics material from the first side and will exit through the second side. If more than two layers of ink were provided on the second side, the blade may drag with it part of the ink at the perimeter particularly if there were several layers of ink provided at the perimeter. Where several layers of ink are provided at the perimeter the probability of a separating of any one or more of the layers of ink from each other or from the substrate is increased. Accordingly the edge web provides significant advantage in the manufacturing of the card of the present invention.

The application of the ink may be by silk screen printing, which is preferably the way in which the second layer is applied, and by either or both of high resolution gravure and UV offset for the first layer and/or the masking layer. The inks that may accordingly be used may for example be an air dried silk screen ink and a UV cured high resolution 4 colour process ink.

Reference is now made to an additional feature to the cards as shown in the basic form of FIGS. 1 to 3 and with the additional features of FIGS. 4 to 15 and accordingly reference is made to FIG. 16 which show one form of a frangible aspect to the embodiment of the present invention. In this form the frangible part may be separated as a token to allow the redemption of a prize of for other monies worth. The card may be a give away or a prize in a competition and can be taken to for example a CD store to redeem the value of the card for a discount on a CD or the like. The store person will snap a portion of the card of thereby indicating that the card has been used to redeem the one off redemption. With the provision of the 3D effect printing on the cards, it will make it much more difficult for the card to be forged thereby giving it better security than a plain printed card.

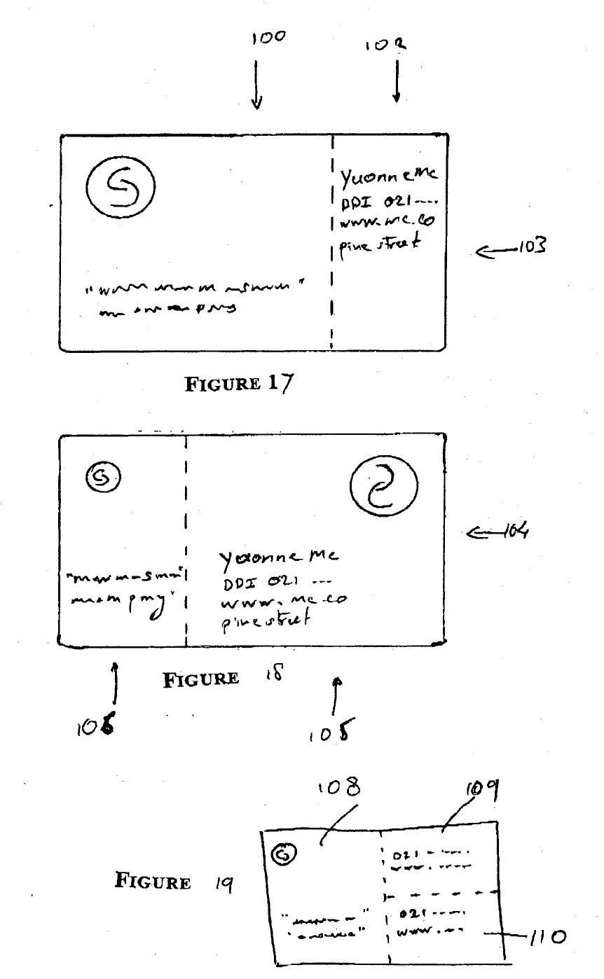

Another variation to the card is shown in with reference to FIG. 17-19. There is shown a business card which is for example of a substantially rectangular outline shape. The card may incorporate any one or more of the layering examples as herein described. Each major surface or side of the business card is provided with exposed printed information such as text.

Each surface is provided with at least two regions 100, 102 and 105, 106 which are separated by a line of weakness such as for example perforations there between.

In effect, the card may be considered to be provided into frangible portions however with reference to the terminology of being provided with regions, the first region of the first major surface 103 as shown in FIG. 17, is provided with information and indicia such as for example company details and logos or the like.

This information is substantially repeated on the second region 106 of the second surface 104 as shown in FIG. 18. The second region 106 is provided on the opposite side to the card where the second region 102 of the first surface 103 is provided. The second region 102 of the first surface 103 is provided with information such as for example the name of a person and contact details and the like. This information is substantially repeated on the first region 105 of the second surface 104 of the card. Hence effectively each major surface of the card is provided with substantially similar information in total. When the card is frangibly separated that portion of the card provided with the second region 102 of the first surface 103 and the second region 106 of the second surface 104 also provides the same or substantially similar information to that which is provided on the first region 201 of the first surface 103 and the first region 105 of the second surface 104 by frangible separation.

Therefore once a business card has been handed out to a person, the business card can be frangibly separated into two portions, wherein the recipient can then give one portion away to a third party. Both portions contain substantially the same information provided on the two sides, such that both the recipient and a third party have a portion of the card which at least as far as what is presented on the card is substantially the same and provides substantially similar utility.

The card may be provided with perforations which provide the two regions in a same size or different size as for example shown in FIGS. 17 and 18. The primary recipient may retain the larger portion of the card giving the frangibly separated smaller portion to a third party so that the original unitary business card can provide appropriate details to more than one person once separated to thereby provide a multi point reference. More than two regions may also be provided but then in order to convey the same information on each portion will require a repeat of the first or second indicia.

Where reference herein is made to application of a layer “over” another, it is to be appreciated that this may not limit the application of any additional layers being provided intermediate. Furthermore it will be appreciated that reference to the application of a layer to the bounds of another mat include an offset which may be provided for the purposes of providing exposure of a layer captured underneath that which has been defined as being extended to the bounds, for visual affect.

We claim:

1. A card with three dimensional visual effect comprising
a transparent or translucent substrate of a flat nature and having a first major surface and an opposite second major surface
an opaque first layer of ink printed over (and preferably onto) at least part of said first major surface of said substrate and
a second layer of ink printed over (and preferably onto) at least part of said second major surface of said substrate
an opaque masking layer of ink printed onto at least part of said second layer to capture at least part of said second layer between said substrate and said masking layer,
wherein said first layer is provided on said first major surface side of said substrate in a region or regions selected whereby visual exposure of part of said second layer is provided, visible from said first major surface side of said card.

2. A card as claimed in claim 1 wherein said first layer is block applied to at least said part of said first major surface, save for including a region of regions within its perimeter where an opening or openings are provided through such first layer and whereby part of said second layer is visible from said first major surface side of said card thought at least part of at least one of said opening(s).

3. A card as claimed in claim 1 wherein said second layer is of a colour or colours which contrast with said first layer.

4. A card as claimed in claim 1 wherein said second layer is of a colour or colours which contrast with said masking layer.

5. A card as claimed in claim 1 wherein said second layer is of a colour or colours which is the same as said masking layer.

6. A card as claimed in claim 1 wherein said masking layer is applied over the entire second layer.

7. A card as claimed in claim 6 wherein said masking layer captures all of said second layer.

8. A card as claimed in claim 1 wherein said masking layer captures most of said second layer.

9. A card as claimed in claim 8 wherein said masking layer overlies most of said second layer.

10. A card as claimed in claim 8 wherein said masking layer is pattern applied and defines a non applied region thereof over said second layer where said second layer is visible from said second major surface side of said card.

11. A card as claimed in claim 1 wherein said first layer is of a one ink colour only.

12. A card as claimed in claim 1 wherein said first layer is of a first colour applied in one region over said first major surface and of at least one other colour applied in a different region over said first major surface.

13. A card as claimed in claim 1 wherein an over layer of ink is provided over at least part of said first layer.

14. A card as claimed in claim 13 wherein said over layer is applied directly onto at least part of said first layer.

15. A card as claimed in claim 13 wherein said over layer is a layer defining indicia printed onto said first layer.

16. A card as claimed in claim 13 wherein said over layer is text printed onto said first layer.

17. A card as claimed in claim 13 wherein said over layer is of a contrasting colour to said first layer.

18. A card as claimed in claim 1 wherein said region or regions of said first layer through which said second layer is visible are openings of said first layer defining reverse text such that the second layer visible though said openings provides the colour to the legible text visible from said first major surface side of said card as defined by said openings of said first layer.

19. A card as claimed in claim 18 wherein said over layer is provided about said region(s) of said first layer where said openings are provided and wherein corresponding openings are provided through said over layer.

20. A card as claimed in claim 1 wherein said second layer is not coextensive with said substrate and defines regions where no second layer is applied to said substrate, at least some of such being regions at least partially transparency through said card.

21. A card as claimed in claim 1 wherein said second layer is blanked applied to said second major surface of said substrate save for at least one non applied region within the bounds of said second layer.

22. A card as claimed in claim 21 wherein on said first major surface side of said substrate, a non coated region remains which is commensurate with at least part of said non applied region of said second major surface.

23. A card as claimed in claim 21 said first layer is applied to said first major surface of said substrate, save for at least at regions where said non applied region of said second layer is provided.

24. A card as claimed in claim 21 wherein at said non applied region, the edge of said first layer is commensurate with the edge of said second layer save for an offset parallel therewith along at least part of said edge of said second layer bounded by said non applied region, in order to reveal a thin line of said second layer bounded by said non applied region and visually bounded by said first layer when viewed from said first major surface side of said card.

25. A card as claimed in claim 21 wherein no over layer is provided where said non applied region of said second layer exists.

26. A card as claimed in claim 21 wherein on said second major surface side of said substrate, a non coated region remains which is commensurate with said non applied region of said second major surface.

27. A card as claimed in claim 21 wherein said opaque masking layer is applied over said second layer, save for at least at regions where said non applied region of said second layer is provided.

28. A card as claimed in claim 21 wherein said masking layer is applied over said second layer save for a region offset and parallel to at least part of an edge of said second layer at said non applied region.

29. A card as claimed in claim 28 wherein said edge of said second layer is provided within the bounds of said second layer.

30. A card as claimed in claim 21 wherein the edge of said masking layer is commensurate with said second layer save for an offset parallel therewith along at least part of an edge thereof adjacent said non applied region, in order to reveal a thin line of said second layer bounded by said non applied region and bounded by said second layer when viewed from said second major surface side of said card.

31. A card as claimed in claim 1 wherein said opaque masking layer has printed text or graphics provided thereon visible from the second major surface side of said substrate.

32. A card as claimed in claim 21 wherein said second layer is blanket applied to the entire second major surface of said substrate save for said non applied regions and save for an offset inwardly from the perimeter of said substrate.

33. A card as claimed in claim 1 wherein said opaque masking layer does extend to the perimeter of said substrate and beyond said region off set of said second layer to said substrate perimeter where said masking layer is applied directly onto said second major surface of said substrate.

34. A card as claimed in claim 32 wherein said offset inwardly from said perimeter is approximately 0.5 mm.

35. A card as claimed in claim 32 wherein said second layer is substantially coextensive with said opaque masking layer save for at said offset inwardly from said perimeter.

36. A card as claimed in claim 21 wherein said opaque masking layer does extend to the perimeter of said substrate and beyond said region off set of said second layer to said substrate perimeter where said masking layer is applied directly onto said second major surface of said substrate and wherein said second layer is substantially co extensive with said opaque masking layer save for said offset inwardly from said perimeter and said offset of said opaque layer from said edge of said second layer adjacent said non coated region.

37. A business card of a card of a kind as claimed in claim 1 wherein said card is of a sheet of material providing a first and second exposed major surface, said sheet defining at least two portions separated by a line of weakness,
wherein the first major surface of a first portion provides indicia of a first kind and the second major surface of the second portion provides indicia substantially similar said indicia of said first kind and
wherein the second portion of the first major surface provides indicia of a second kind and the first portion of said second major surface provides indicia substantially similar said indicia of said second kind

38. A business card as claimed in claim 37 wherein said indicia of said first kind is different to that of said second kind.

39. A business card as claimed in claim 37 wherein said indicia of said first kind includes a persons name.

40. A business card as claimed in claim 37 wherein said indicia of said first kind includes a company name.

41. A business card as claimed in claim 37 wherein said indicia of said first kind includes a logo or slogan of descriptive matter realign to the activities of the company with said company name.

42. A business card as claimed in claim 37 wherein said indicia of said second kind includes contact details.

43. A business card as claimed in claim 37 wherein said indicia of said second kind includes a persons name.

44. A business card as claimed in claim 37 wherein said first portion is larger than said second portion.

45. A business card as claimed in claim 37 wherein said first portion is smaller than said second portion.

46. A business card as claimed in claim 37 wherein said first portion is the same size as said second portion.

47. A business card as claimed in claim 37 wherein said business card is rectangular in shape.

48. A business card as claimed in claim 37 wherein said line of weakness is a line of perforations.

49. A business card as claimed in claim 37 wherein said line of weakness extends between the longer of said sides of said rectangular shaped business card.

50. A business card as claimed in claim 37 wherein said first kinds of indicia are also graphically of a similar layout.

51. A business card as claimed in claim 37 wherein said second kinds of indicia are also graphically of a similar layout.
